(19) United States
(12) Patent Application Publication
(10) Pub. No.: US 2014/0317081 A1
(43) Pub. Date: Oct. 23, 2014

(54) SYSTEM AND METHOD FOR SESSION DATA MANAGEMENT

(71) Applicant: Sessionbox, Inc., San Francisco, CA (US)

(72) Inventors: Henri Dubois-Ferriere, San Francisco, CA (US); Alfred Landrum, San Francisco, CA (US)

(73) Assignee: Sessionbox, Inc., San Francisco, CA (US)

(21) Appl. No.: 14/259,915

(22) Filed: Apr. 23, 2014

Related U.S. Application Data
(60) Provisional application No. 61/815,119, filed on Apr. 23, 2013.

(51) Int. Cl. H04L 12/24; G06F 17/30

(52) U.S. Cl. CPC H04L 41/024; G06F 17/30321; G06F 17/30106
USPC 707/706

(57) ABSTRACT

Embodiments relate generally to computer hardware, computer software, methods for session data management. More specifically, disclosed are systems, components, and methods to cause a session capture agent to generate a session capture, cause a session processor to generate individual session segments from the session capture, cause a session search engine to locate one or more session segments using a session query process, and retrieve the one or more session segments.

### RELATED APPLICATIONS

This application claims priority to U.S. provisional application 61/815,119, filed Apr. 23, 2013, and entitled “Managing Session Data”, the disclosure of which is hereby incorporated herein by reference in its entirety for all purposes.

### FIELD OF THE INVENTION

Embodiments relate generally to computer hardware, computer software and methods for session data management. More specifically, disclosed are approaches that provide for functionality such as session capture, processing, search, and replay, among other such actions.

### BACKGROUND

Application sessions generally involve information that is transferred between a user and an application, such as a Web application, during a period of time. Generally, application sessions generate and accumulate substantial amount of data, including data generated form the application and data entered by the user, as well as metadata about the user and the application. Application session can further include information relating to how the user is interacting with the application and historical performance of the application.

There is a need to fully analyze and understand application sessions between a user and an application. For example, when a user of a web application reports a problem with the web application usage, the detailed application session data can help the web application provider to find out what happened at the client side and thus solve the issue.

Existing technologies only partially record or analyze the application sessions. Examples of such technologies include web crawler technology, web archive technology, desktop recording technology, network session-based capture technology, and client-side web widgets which includes web analytics widgets primarily for tracking user actions and web performance widgets primarily for tracking performance metrics.

Thus, there is a need to manage the application sessions in a dynamic and holistic approach to analyze and understand application sessions.

### BRIEF DESCRIPTION OF THE DRAWINGS

Various embodiments or examples (“examples”) of the invention are disclosed in the following detailed description and the accompanying drawings:

FIG. 1 illustrates an example of the session management system, according to some embodiments;

FIG. 2 is a block diagram illustrating an example of the session management system, according to some embodiments;

FIG. 3 is a block diagram illustrating another example of a session management system with a proxy server, according to some embodiments;

FIG. 4 is an example flow diagram for the session management system, according to some embodiments;

FIG. 5 is another example flow diagram for session management system, according to some embodiments;

FIG. 6 illustrates an exemplary computing platform disposed a computing device, according to some embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

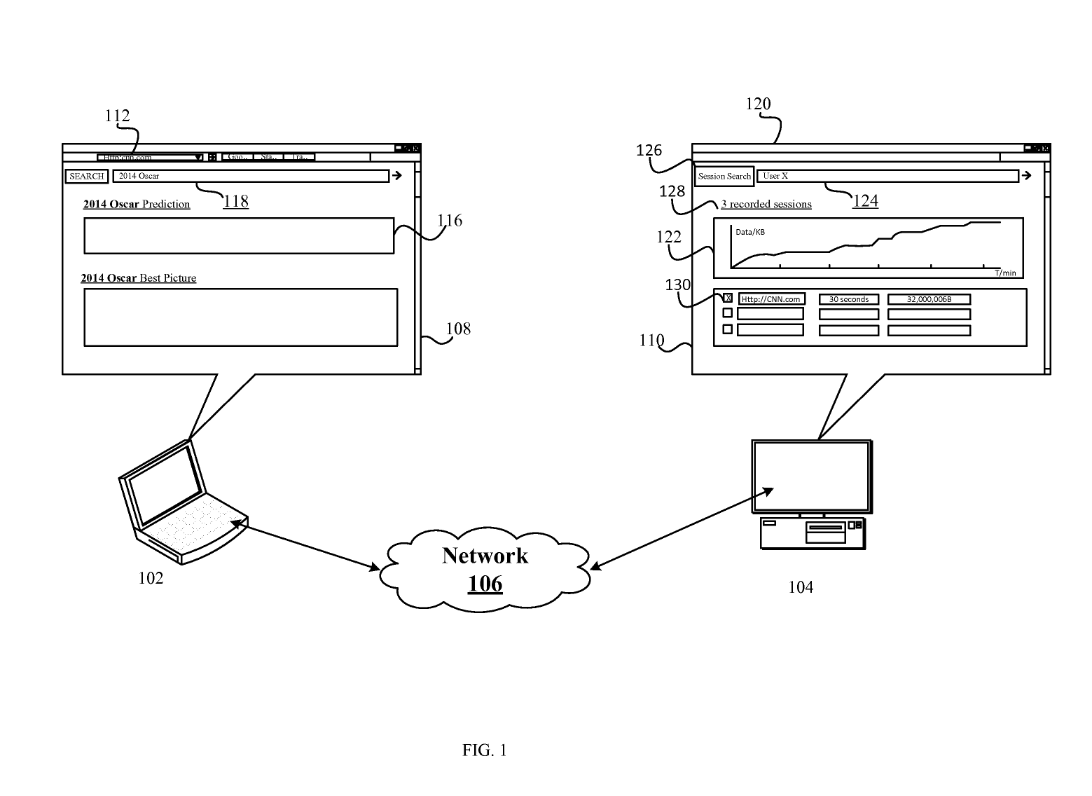

FIG. 1 illustrates an example of the session management system, wherein a session associated with a client computing device 102 can be captured, stored, searched and identified at a session monitoring device 104. In one embodiment, a client computing device 102 can be connected to a session monitoring device 104 through a network 106. The client computing device 102 and session monitor device 104 can each include any appropriate device operable to send and receive requests, messages, or information over an appropriate network 106 and convey information back to a user of the device. Examples of such devices include a desktop computer, a laptop computer, a portable electronic device such as a tablet, a mobile phone, and the like. In one embodiment, session monitoring device 104 is a device different from client computing device 102. In another embodiment, session monitoring device 104 can be the same client computing device 102. Network 106 can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections, and combinations thereof. User agent, e.g. 108, is a software agent that runs on the client computing device and acts on behalf of the user interacting with an application. In certain cases, the user agent and client-side application software are separate. For example, in a web application the user agent is a web browser and the application is loaded into the browser as a web page.

In one embodiment, an application session involves data regarding the use of an application by a user in a period, or multiple periods, during which the user is accessing or interacting with the application, such as may include a sequence of interactions between the user and a client computing device, and between the client computing device and other computing devices.

An application session can include an input time series which describes input of a user in a selected period of time. Examples of an input time series include a search term 118 input by the user, a selected website 112 chosen by the user, or any other input events, such as keyboard events, mouse movements, mouse clicks, stylus movements, or touch gestures.

Application session also can include an output time series which describes output of an application in response to the user's input events in a selected period of time. Examples of an output time series include a search result 116, or any other output events displayed by user agent 108. In this example, the application session is related to a user X (not shown).

Referring to FIG. 1, in one embodiment, a dashboard 110 associated with a display 120 of the session monitor device 104 can be used to display a session search result, with mechanisms and methods described herein. For example, a session manager can type a key word, e.g. “User X”, in an input box 124, and conduct a session search 126 for sessions related to user X in the session store. In one embodiment, the result of a session search 128 includes, for example, a session aggregation chart that can represent user X related session data over a selected period of time, or a list of user X related application sessions. In addition, the session manager can select an application session 130 and perform one or more session analyses, including replaying, editing and trouble shooting, etc. In this example, the selected application session 130 can include an input time series which describes input of a user in a selected period of time, e.g. 112 and 118, and an output time series which describes output of an application in response to the user's input events in a selected period of time, e.g. 116.

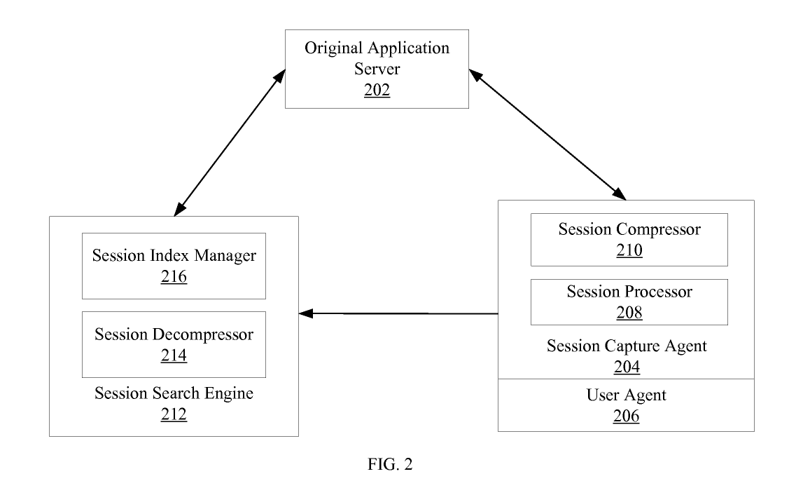

FIG. 2 is a block diagram illustrating an example of the session management system, according to some embodiments. In one embodiment, the session management system includes, for example, original application server 201 which can provide the application running on a client computing device, user agent 206 associated with the client computing device, session capture agent 204 including session processor 208 and session compressor 210 for processing a session capture, and session search engine 212 including session decompressor 214 and session index manager 216 for conducting a session search.

In one embodiment, session capture agent 204 can capture session data from an application session and generate a session capture. In one embodiment, the session capture can include an input time series which describes input of a user in a selected period of time, e.g. a mouse click at a selected web link, and text input for a web search. Moreover, the session capture can include an output time series which illustrates the application's response for the user's input in a selected period of time, e.g. loading of a web link, and displaying of a search result. The session capture can also include session metadata which describes general information of the user and the application. In addition, the input and output time series do not always have the same length as their time stamps are generally different.

The input time series in at least one embodiment is a sequence of tuples I=(u₀, I₀), (u₁, I₁) . . . (uₙ, Iₙ), where the uₙ are timestamps, and the Iₙ are records of user input events, such as keyboard events, mouse movements, mouse clicks, stylus movements, or touch gestures. For example, the Iₙ can be represented using a structured format such as JSON or XML, or may be a translation of a binary representation of input events used by the operating system, GUI framework, or user agent 206.

According to some embodiments, session capture agent 204 can employ different approaches to capture input time series. In one embodiment, session capture agent 204 can intercept certain user agent API calls related to receiving or handling user input events through a shim library. In another embodiment, session capture agent 204 can register event handlers that are notified of user input events through user agent API calls. Still in another embodiment, session capture agent 204 can use generic instrumentation facilities of user agent 206 to gather information about user input events.

The output time series in this example is a sequence of tuples O=(t₀, O₀), (t₁, O₁) . . . (tₘ, Oₘ), where the tₘ are timestamps, and each Oₘ is the structured output document displayed by user agent 206 at the corresponding time tₘ. For example, if a user agent is using a UI toolkit such as Cocoa Touch, then Oₘ is a structured document representation of the UI display contents, derived from an abstract representation of the UI state in terms of structured UI constructs and their content.

In one embodiment, the structured output document of a user agent can be expressed as:

Oₖ=(Dₖ,rₖ¹,rₖ², . . . rₖⁿ,)

where Dₖ is the structured output document and r^{j}ₖ are external resources. In such an environment, the output document time series can be referred to as D=(t₀, D₀), (t₁, D₁), . . . (tₘ, Dₘ). For example, user agent 206 can use a Document Object Model (DOM) as a runtime representation of an output document including a markup language such as XML or HTML. In this example, Dₖ is a serialization of the DOM at time tₖ and external resources including images, style sheets and other resources. The external resources are identified by identifiers such as a Uniform Resource Locator (URL), and each resource is included in Dₖ by a link including the resource's URL.

According to some embodiments, session capture agent 204 can employ different approaches to capture output time series, partially depending on the environment in which session capture agent 204 operates, e.g. the APIs provided by user agent 206 and the APIs provided by the hosting operation system associated with user agent 206.

In one embodiment, session capture agent 204 can call user agent 206 to retrieve the current output document (i.e. full-pulling approach). In another embodiment, session capture agent 204 can register with user agent 206's APIs in order to receive notifications at the change of the output document (i.e. full-change notification approach). Still in another embodiment, if user agent 206 provides appropriate APIs, session capture agent 206 can retrieve change notifications listing the changes in the output document (i.e. delta change notification). Yet in another embodiment, session capture agent 204 can intercept certain user agent API calls related to updating or modifying the output document (i.e. delta intercept approach).

Session metadata can be stored in session metadata records using a structured format such as JSON or XML. Metadata records can contain any auxiliary information that is related to the session but is not contained in the output or input time series. Session metadata record types include temporal or non-temporal. For example, session metadata about the application name and user name are probably non-temporal, whereas metadata about network traffic are likely to be temporal.

According to some embodiments, session capture agent 204 can employ different approaches to capture session metadata. In one embodiment, session capture agent 204 can query user agent 206 to gather session metadata through user agent 206's APIs. In another embodiment, session capture agent 206 can query the client computing device to gather session metadata through host operating system's APIs. Still in another embodiment, session capture agent 206 can register with user agent 206's APIs and or with host operation system's APIs to receive notification when state associated with session metadata changes.

In addition, some session metadata can be extracted from the session input series and session output series. For example, in certain environments, it may only be possible to determine session metadata such as the application name of a session or the login name of a session user by inspection of the input series or output series.

Still referring to FIG. 2, in one embodiment, session capture agent 204 can be a plugin or extension facility added to user agent 206. For example, when user agent 206 is a web browser, the modification of that web browser to include session capture agent 204 may be achieved by adding a plugin or browser extension that includes a session capture agent. In another example, the browser can be replaced with a different, customized browser that has built-in session capture agent functionality.

In one embodiment, after generating a session capture, in one embodiment, session processor 208 associated with session capture agent 204 or session search engine 212, can slice and segment the session capture including input times series, output time series and session metadata. Both session capture slicing and segmentation can separate a session capture into contiguous portions. But session capture slicing can operate over long timescales and is driven by long timers and/or infrequent session events, whereas session capture segmentation can operate over short timescales and is driven by short timers and/or frequent session events.

In one embodiment, session processor 208 can slice a long session capture into smaller individual session captures. The result of this slicing is a number of shorter, separate captures that are then processed and handled separately.

In another embodiment, session processor 208 can segment the input/output series into contiguous segments. For example, given a document time series D=(t₀, D₀), (t₁, D₁, . . . (tₘ, Dₘ), a possible segmentation consists of the three segments Sₐ=(t₀, D₀), (t₁, D₁), S_{b}=(t₂, D₂), and S_{c}=(t₃, D₃), . . . (tₘ, Dₘ).

According to some embodiments, session processor 208 can employ different approaches to slice or segment the input/output time series. In one embodiment, one segmentation process is driven by the time elapsed since the last segment was segmented or emitted. In another embodiment, one segmentation process is driven by the amount of data in the segment. Still in another embodiment, a segmentation process is driven by the output time series, the input time series, session metadata through using these data to place segment boundaries that reflect aspects of user activities and semantics of a session, i.e. session-driven segmentation.

Referring to FIG. 2, in one embodiment, session compressor 210 can compress the session segments to reduce data amount for transmitting. In one embodiment, when session search agent 204 and session search engine 212 are in separate locations and are connected by a network with bandwidth or latency constraints, session capture is compressed prior to being transmitted from session search agent 204 to session search engine 212.

In one embodiment, the compression process can include a two-stage process: a lossy compression process and a lossless compression process. For example, a lossy compression process can be a process that removes comments present in the markup of the document in the input segment. After the lossy compression process, a lossless compression process can include a delta encoding process, followed by an inter-segment compression process and an intra-segment compression process. In another embodiment, the compression process can include only a lossless compression process.

After the compression process, session capture data is transferred from session capture agent 204 to session search engine 212 using an underlying connection-oriented, ordered-delivery transport protocol that is provided by the host operating system associated with session capture agent 204 and session search engine 212. In one embodiment, the protocol can include one of a TCP, IP, FTP or a web-based protocol.

In another embodiment, each of the session capture, session processing including session slicing and/or segmentation, or session compression can be non-sequential to each other. For example, the session capture and the session slicing/segmentation can be concurrent processes.

Still referring to FIG. 2, in one embodiment, after transmitting the session capture data to session search engine 212, session decompressor 214 can decompress the compressed session segments in a session decompression process. In one embodiment, the session decompression can reverse the various stage of compression including, for example, a lossy compression and a lossless compression. In another embodiment, the output of the session decompression process can retain segment boundaries by encoding them into the decompressed session time series, or as additional metadata as it can be used in the later indexing process.

After the session decompression process, each session capture is assigned a unique session identifier (SID) in a session identification process. In one embodiment, the session identification is preceded by a slicing process that breaks long session captures into shorter sessions to improve the index and search efficiency of session search engine 212. In another embodiment, session capture agent 204 can assign the SID at the generation of each session capture. Yet in another embodiment, session search engine 212 can assign the SID to each session capture after the processes described herein.

After the session identification process, session index manager 216 can process the resulting session captures including session time series, or input/output time series components, in a session indexing process. The session indexing process can generate and maintain session indices for an efficient session search. In one embodiment, the session indexing process can include at least one of a term extraction process, a global index update process and a session index update process, as explained herein. The different processes are described separately for clarity, but practitioners skilled in the art should understand these processes can be implemented jointly or independently as needed.

A term extraction process, for example, can create a list of terms present in a session capture. Terms can include words and other constructs such as numbers or identifiers, e.g. social security numbers. For example, to extract terms from the output time series components, the term extract process can parse through each document in an output session segment. To extract terms from the input time series components, the term extract process can extract keystroke events, accumulate the result of those keystroke, and parse the text in each document.

A global index update process, for example, can store and update the list of terms generated by the term extraction process. A global index is a dictionary that maps each term appearing in the input/output time series components to a list of SIDs containing the corresponding terms. In one embodiment, the global index can include an additional global metadata index for frequently used metadata attributes, e.g. the application name and the user name, thus allowing faster query processing.

A session index update process, for example, can store and update session indices associated with each session capture. A session index is a dictionary that can map terms or events to a list of temporal locations where the term (or event) appears in a session capture.

In one embodiment, a session capture can have at least an output index and an input index. In an output index, each temporal location can be a discrete time or an interval, depending on whether the term appears in a single document or remains present in multiple sequential documents. In an input index, each temporal location can be a discrete time. In addition, an input index can map both terms and non-textual UI input event (e.g. mouse clicks or touch gestures) to their temporal locations. In another embodiment, a session capture can have a metadata index.

After the session index process, the outcome sessions can be stored in a session store using a compressed or uncompressed format. In one embodiment, the session store can use tiering and caching mechanism to improve access speed for retrieval of frequently used/searched sessions. In another embodiment, the session store can be distributed across multiple nodes for increased performance, scalability and robustness.

Still referring to FIG. 2, session search engine 212 can conduct a session search for session captures associated with chosen session search queries. Session search queries can use a number of search atoms composed of known search operators in the art, e.g. Boolean operators. Examples of search atoms include keyword atoms, non-keyword atoms such as a mouse click or touch gesture, and metadata attributes such as a particular user or application.

For the session search process, different search entry interfaces can be employed independently or jointly. In one embodiment, a search entry interface can use search queries expressed in a text-based syntax. In another embodiment, a search entry interface can use a combination of GUI elements, e.g. drop-down menus, and text boxes.

According to some embodiments, the session search process can include a multi-stage query process using the indices described herein to locate the matching sessions.

After the session search process, the system transmits the results of the search, e.g. the SIDs for the matching sessions, to a display process, which may use different display methods to present the session search outcome.

In one embodiment, the system can display a list of abbreviated session descriptions to describe the results of the search. In another embodiment, the system can display a list of session timelines including a horizontal strip representing the session's temporal axis. Still in another embodiment, the system can use a full session reply widget to allow replay a session, including playback controls, e.g. “play”, “rewind” and “fast forward”.

In addition, the system can display additional information for aiding the user to navigate the search results. For example, when a search query for “click: search” generates multiple identified input events in a session, the system can display a timeline to show the user where the matches, e.g. “search”, occurred.

According to some embodiments, the system can employ session analytics to the result of a session search. For example, a mathematical or statistical operator can extract distributions or other statistics of identified sessions from a session search. In another example, a graphical visualization can visualize the identified sessions. Yet in another example, a data extraction operator, e.g. a Xpath query, can extract data in a search result.

According to some embodiments, besides all processes described herein, the session management system can conduct an additional process to retrieve external resources that are linked to session documents. In one embodiment, the external resource retrieval process can be part of the decompression process or be independent of the decompression process. In another embodiment, session search engine 212 can conduct the external resource retrieval process.

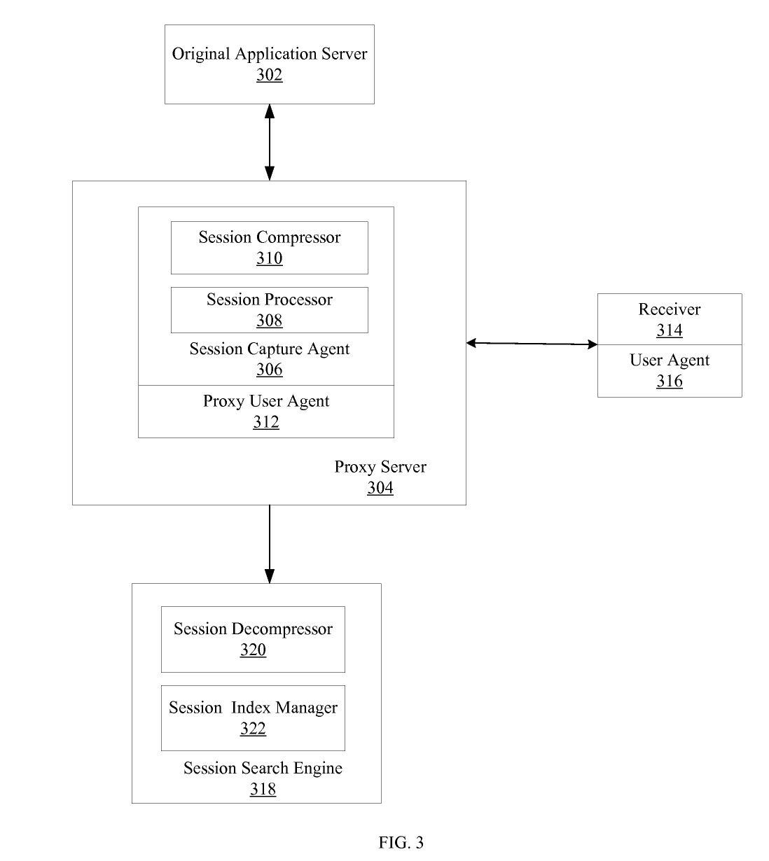

FIG. 3 is a block diagram illustrating another example of a session management system including a proxy server 304, according to some embodiments. In one embodiment, the session management system includes, for example, original application server 302, user agent 206 associated with the client computing device, receiver 314 executing in conjunction with user agent 316, proxy provider 304 associated with proxy user agent 312, session capture agent 306 including session processor 308 and session compressor 310, and session search engine 318 including session decompressor 320 and session index manager 322.

According to some embodiments, the use of proxy server 304 can eliminate the need to install a user agent customization plugin, e.g. session capture agent 306, on the client computing device. Particularly, the use of proxy server 304 can be useful when a client computing devise employs a closed and incompatible operating platform.

Referring to FIG. 3, receiver 314 can, in lieu of the original user agent, execute in conjunction with user agent 316 on a client computing device. For example, receiver 314 can receive output document from proxy user agent 312, and send user input on the client computing device to proxy user agent 312. In addition, the implementation of receiver 314, and the communication protocol between receiver 314 and proxy user agent 312 can be derived from well-known techniques such as “thin client” or “remote windowing” architectures, and the like, e.g. the X Window System, or the Citrix Independent Computing Architecture (ICA). Other procedures and components for session management system in FIG. 3 are similar to FIG. 2 and will not be discussed herein in detail.

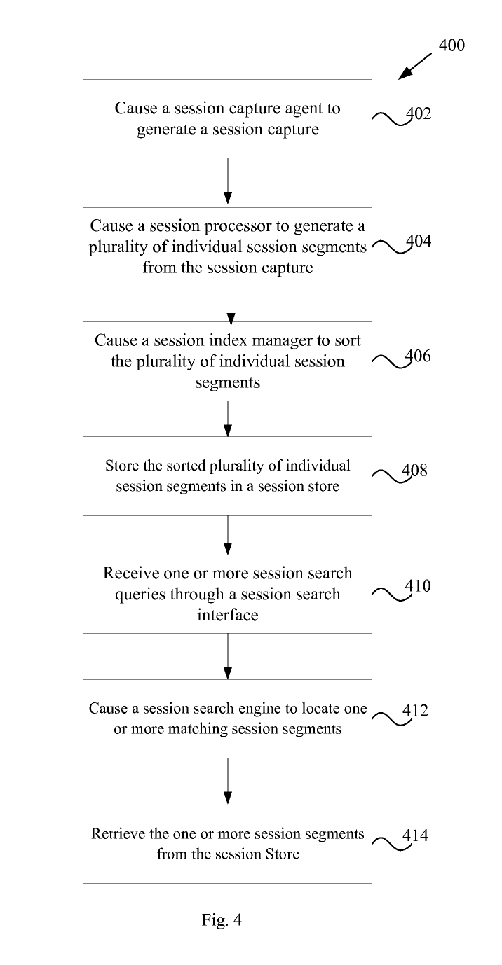

FIG. 4 is an example flow diagram 400 for the session management system, describing the optional steps in the session capture, segmentation, compression/decompression and index processes. It should be understood that there can be additional, fewer, or alternative steps performed in similar or alternative orders, or in parallel, within the scope of the various embodiments unless otherwise stated. At 402, a session capture agent is caused to generate a session capture on a computing device, the session capture capturing session data from an application session, the session data including at least one of an input time series, an output time series, or session metadata. At 404, a session processor is caused to generate a plurality of individual session segments from the session capture by at least one of slicing or segmenting the session data. At 406, a session index manager is caused to sort the plurality of individual session segments using an indexing process, the indexing process including at least one of a term extraction process, a global index update process, or a session index update process. At 408, the sorted plurality of individual session segments are stored in a session store. At 410, one or more session search queries through a session search interface are received. At 412, a session search engine is caused to locate one or more matching session segments using a session query process. At 414, the one or more matching session segments are retrieved from the session store

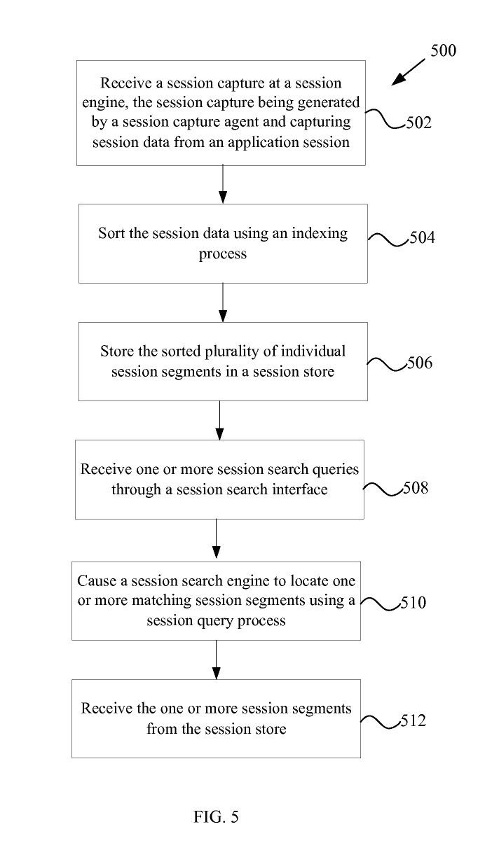

FIG. 5 is another example flow diagram for session management system, illustrating the optional steps via a client computing device. It should be understood that there can be additional, fewer, or alternative steps performed in similar or alternative orders, or in parallel, within the scope of the various embodiments unless otherwise stated. At 502, flow diagram 500 begins with receiving a session capture at a session search engine associated with a session monitoring device, the session capture being generated by a session capture agent associated with a client computing device and capturing session data from an application session, the session data including at least one of an input time series, an output time series, or session metadata. At 504, an index process is used to sort the session data, the indexing process including at least one of a term extraction process, a global index update process, or a session index update process. At 506, the sorted session data are stored in a session store. At 508, one or more session search queries are received through a session search interface. At 510, a session query process is used to locate one or more matching session data. At 512, the one or more matching session data are retrieved from the session store.

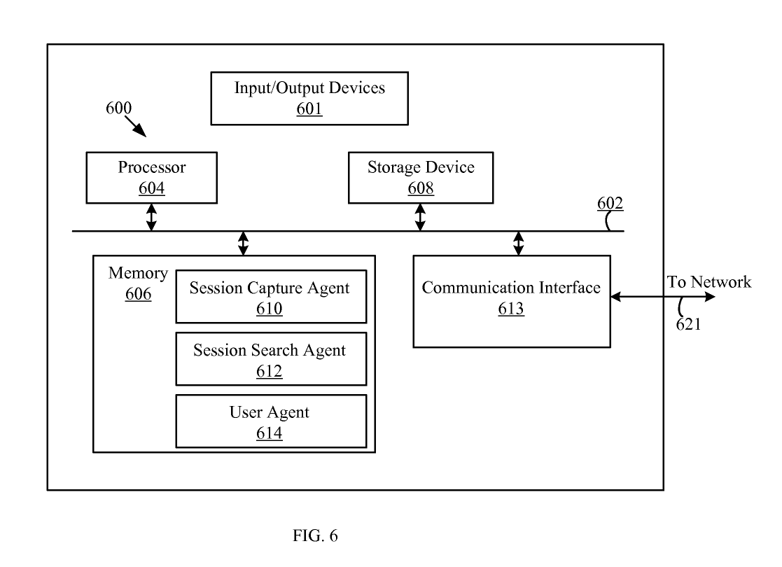

FIG. 6 illustrates an exemplary computing platform disposed in a client computing device, according to some embodiments. In some examples, computing platform 600 may be used to implement computer programs, applications, methods, processes, algorithms, or other software to perform the above-described techniques. Computing platform 600 includes a bus 602 or other communication mechanism for communicating information, which interconnects subsystems and devices, such as processor 604, system memory 606 (e.g., RAM, etc.), storage device 608 (e.g., ROM, etc.), a communication interface 613 (e.g., an Ethernet or wireless controller, a Bluetooth controller, etc.) to facilitate communications via a port on communication link 621 to communicate, for example, with a session monitoring device or a session server, including mobile computing and/or communication devices with processors. Processor 1004 can be implemented with one or more central processing units (“CPUs”), such as those manufactured by Intel® Corporation, or one or more virtual processors, as well as any combination of CPUs and virtual processors. Computing platform 1000 exchanges data representing inputs and outputs via input-and-output devices 1001, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 600 performs specific operations by processor 604 executing one or more sequences of one or more instructions stored in system memory 606, and computing platform 600 can be implemented in a client-server arrangement, peer-to-peer arrangement, or as any mobile computing device, including smart phones and the like. Such instructions or data may be read into system memory 606 from another computer readable medium, such as storage device 608. In some examples, hard-wired circuitry may be used in place of or in combination with software instructions for implementation. Instructions may be embedded in software or firmware. The term “computer readable medium” refers to any tangible medium that participates in providing instructions to processor 604 for execution. Such a medium may take many forms, including but not limited to, non-volatile media and volatile media. Non-volatile media includes, for example, optical or magnetic disks and the like. Volatile media includes dynamic memory, such as system memory 606.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 602 for transmitting a computer data signal.

In some examples, execution of the sequences of instructions may be performed by computing platform 600. According to some examples, computing platform 600 can be coupled by communication link 621 (e.g., a wired network, such as LAN, PSTN, or any wireless network) to any other processor to perform the sequence of instructions in coordination with (or asynchronous to) one another. Computing platform 1000 may transmit and receive messages, data, and instructions, including program code (e.g., application code) through communication link 621 and communication interface 613. Received program code may be executed by processor 604 as it is received, and/or stored in memory 606 or other non-volatile storage for later execution.

In the example shown, system memory 606 can include various modules that include executable instructions to implement functionalities described herein. In the example shown, system memory 606 includes a session capture agent 610, a session search agent 612 and a user agent 616, each can be configured to provide one or more functions described herein.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A system for managing session data, comprising:
one or more processors; and
one or more memory devices including instructions that, when executed by the one or more processors, cause the system to:
cause a session capture agent associated with a client computing device to generate a session capture, the session capture capturing session data from an application session, the session data including at least one of an input time series, an output time series, or session metadata;
cause a session processor to generate a plurality of individual session segments from the session capture by at least one of slicing or segmenting the session data;
cause a session index manager to sort the plurality of individual session segments using an indexing process, the indexing process including at least one of a term extraction process, a global index update process, or a session index update process;
store the sorted plurality of individual session segments in a session store;
receive one or more session search queries through a session search interface;
cause a session search engine to locate one or more matching session segments using a session query process; and
in response to locating the one or more matching session segments, retrieve the one or more matching session segments from the session store.

2. The system of claim 1, wherein the instructions when executed further cause the system to:
transmit the plurality of individual session segments from the session capture agent to the session search engine through a selected protocol, the selected protocol including one of a TCP, IP, FTP or a web-based protocol.

3. The system of claim 1, wherein the instructions when executed further cause the system to:
cause a session compressor to compress the plurality of individual session segments; and
cause a session decompressor to decompress the compressed plurality of individual session segments.

4. The system of claim 3, wherein the session compressor is configured to compress the plurality of individual session segments using at least one of a lossy compression and a lossless compression.

5. The system of claim 1, wherein the instructions when executed further cause the system to:
assign a session identifier (SID) to each of the plurality of individual session segments, wherein the session identifier is used to locate and retrieve each of the matching one or more session segments.

6. The system of claim 1, wherein the instructions when executed further cause the system to:
display the one or more matching session segments using a displaying interface including at least one of a session summary, a session replay, and a session time chart.

7. The system of claim 1, wherein the session query process includes a multi-stage query process.

8. The system of claim 1, wherein the one or more session search queries includes at least one of a text input, an audio input, and a GUI element.

9. The system of claim 1, wherein the instructions when executed further cause the system to:
enable the session search engine to retrieve data from one or more external resources.

10. The system of claim 1, wherein the session capture is at least associated with an input index and an output index.

11. A computer-implemented method, comprising:
under control of one or more computer systems configured with executable instructions, causing a session capture agent associated with a client computing device to generate a session capture, the session capture capturing session data from an application session, the session data including at least one of an input time series, an output time series, or session metadata;
causing a session processor to generate a plurality of individual session segments from the session capture by at least one of slicing or segmenting the session data;
causing a session index manager to sort the plurality of individual session segments using an indexing process, the indexing process including at least one of a term extraction process, a global index update process, or a session index update process;
storing the sorted plurality of individual session segments in a session store;
receiving one or more session search queries through a session search interface;
causing a session search engine to locate one or more matching session segments using a session query process; and
in response to locating the one or more matching session segments, retrieving the one or more matching session segments from the session store.

12. The computer-implemented method of claim 11, further comprising:
transmitting the plurality of individual session segments from the session capture agent to the session search engine through a selected protocol, the selected protocol including one of a TCP, IP, FTP or a web-based protocol.

13. The computer-implemented method of claim 11, further comprising:
causing a session compressor to compress the plurality of individual session segments; and
causing a session decompressor to decompress the compressed plurality of individual session segments.

14. The computer-implemented method of claim 13, wherein the session compressor is configured to compress the plurality of individual session segments using at least one of a lossy compression and a lossless compression.

15. The computer-implemented method of claim 11, further comprising:
assigning a session identifier (SID) to each of the plurality of individual session segments, wherein the session identifier is used to locate and retrieve each of the matching one or more session segments.

16. The computer-implemented method of claim 11, further comprising:
applying one or more analytics to the one or more matching session segments to generate analytic or statistical data.

17. A non-transitory computer readable storage medium storing one or more sequences of instructions executable by one or more processors to perform a set of operations comprising:
receiving a session capture at a session search engine associated with a session monitoring device, the session capture being generated by a session capture agent associated with a client computing device and capturing session data from an application session, the session data including at least one of an input time series, an output time series, or session metadata;
sorting the session data using an indexing process, the indexing process including at least one of a term extraction process, a global index update process, or a session index update process;
storing the sorted session data in a session store;
receiving one or more session search queries through a session search interface;
locating one or more matching session data using a session query process; and
in response to locating the one or more matching session data, retrieving the one or more matching session data from the session store.

18. The non-transitory computer readable storage medium of claim 17, wherein the one or more session search queries includes at least one of a text input, an audio input, and a GUI element.

19. The non-transitory computer readable storage medium of claim 17, further comprising instructions executed by the one or more processors to perform the operations of:
retrieving data from one or more external resources.

20. The non-transitory computer readable storage medium of claim 17, wherein the session capture is at least associated with an input index and an output index.
